(19) United States
(12) Patent Application Publication
(10) Pub. No.: US 2013/0054260 A1
(43) Pub. Date: Feb. 28, 2013

(54) System and Method for Producing Performance Reporting and Comparative Analytics for Finance, Clinical Operations, Physician Management, Patient Encounter, and Quality of Patient Care

(71) Applicant: Paul Evans, Englewood, CO (US)

(72) Inventor: Paul Evans, Englewood, CO (US)

(21) Appl. No.: 13/594,413

(22) Filed: Aug. 24, 2012

Related U.S. Application Data
(60) Provisional application No. 61/526,957, filed on Aug. 24, 2011.

(51) Int. Cl. G06Q 50/22

(52) U.S. Cl. 705/2

(57) ABSTRACT

The business performance management platform system and method enables the capture, extraction, data auditing and data validation processes, combined cost accounting and analytical reporting of data required for certain combined financial, clinical operations, physician encounter, patient encounter, electronic health record, and quality of patient care measures; provides close to real-time data access and performance results; provides financial, operational, clinical, physician encounter, patient encounter, electronic health record, and quality performance dashboards and scorecards, summary level reports, Ad hoc reporting, alerting, emailing, and automated reporting and email distribution, alerting, and modeling functions. The results generated from the business performance management platform provide users of the system critical understanding of detailed and summary level data and information, such as: profit/loss characteristics across the longitudinal data elements associated with patient and physician level detail; cost at patient and physician level; expected revenues; payer performance from payer sources and clinical operations performance.

### RELATED APPLICATION

This application is a continuation of U.S. Patent Application Ser. No. 61/526,957 under an official filing date of Aug. 24, 2011. The entire disclosure of the prior application is considered to be part of the disclosure of the accompanying application and is hereby incorporated by reference.

### FIELD OF THE INVENTION

The present invention is directed to a business, financial, clinical, and quality performance management platform, and in particular, to a system and method to perform accurate reporting, analytics, and comparative benchmarking for healthcare facilities or groups of healthcare facilities in order to determine strategic, operational, and qualitative best practices.

### BACKGROUND AND SUMMARY OF THE INVENTION

In order to effectively operate and manage the business of health care, executives and management require detailed access to timely data and information for making operational and strategic decisions. Near real time data integration and accurate reporting between financial, clinical operations, physician, patient encounter, quality, and 3^{rd} party systems within hospitals and health care facilities, is vital to the survival of the health care system. Further compounding this issue for information access is the massive paradigm shift related to dwindling margins caused by the reduction in reimbursement models and the advent of Healthcare Reform.

The business of health care has changed. The Healthcare Reform law, referred to as the Patient Protection and Affordable Care Act (PPACA), was signed in to effect on March 2010. Under the new law, hospitals and health care providers will be required to update their computer systems and paper-based processes with Electronic Health Record (EHR) computerized systems, and be able to integrate this data with hospital financial, clinical, physician, quality and other third party systems in order to determine and manage patient outcome and overall quality of patient care. In addition, an estimated 30-40 million people within the US will become eligible for health care services under the new law, making performance reporting by individual facility, critical to their success and sustainability.

Further complicating the need for near real time reporting and data accuracy in the health care industry is the formation of Accountable Care Organizations (ACOs), see, e.g., “Medicare “Accountable Care Organizations” Shared Savings Program—New Section 1899 of Title XVIII, Preliminary Questions & Answers”, Centers for Medicare and Medicaid Services. Jan. 10, 2010. An ACO is a healthcare organization characterized by a payment and care delivery model that seeks to tie provider reimbursements to quality metrics and reductions in the total cost of care for an assigned population of patients. A group of coordinated health care providers form an ACO, which then provides care to a group of patients. The ACO may use a range of payment models (capitation, fee-for-service with asymmetric or symmetric shared savings, etc.). The ACO is accountable to the patients and the third-party payer for the quality, appropriateness, and efficiency of the health care provided. According to the Centers for Medicare and Medicaid Services (CMS), an ACO is “an organization of health care providers that agrees to be accountable for the quality, cost, and overall care of Medicare beneficiaries who are enrolled in the traditional fee-for-service program who are assigned to it.” Efficient, accurate, and cost-effective data integration is key to the success of every health care organization.

As cost-shifting with respect to Medicare and Medicaid has become prevalent throughout the industry, the relative relationship between the costs and their associated charges for goods and services has become distorted, charges have been artificially inflated, etc. The ever changing government reimbursement formulas have spawned various cost accounting methodologies and facilities have attempted to develop allocation procedures derived from the management accounting practices. Such standards development approach is costly to maintain due to the dynamic nature of how patients are treated in the healthcare setting, subject to individual physician preferences, changes in technology, and a requirement for a dedicated staff of management engineers. The need for a more efficient, economically and practicably feasible system and method to address such concerns is sorely needed in today's medical service field.

Healthcare service providers frequently look for measures to contain costs or improve cost-effectiveness of their services. Many prior approaches to business solutions for the healthcare industry are solely directed from a patient's point of view, and are thus only related to solutions that arguably improve or manage the products or services offered to the patient or to improve patient's diagnosis and treatment. A better global perspective to the problems and the solutions, however, is required to adequately arrive at solutions to the complex issues facing the current health care marketplace.

### SUMMARY OF THE INVENTION

The present invention is directed to a business, financial, clinical, physician, and quality performance management platform using a data extract, integration, monitoring and processing facility to determine data loading readiness by individual site or department and a data mapping, normalization, validation, and auditing facility and a cost accounting facility. Such platform may be used for: generating, calculating, and modeling integrated reporting for financial (detailed cost, net revenues, expected revenues, profitability, case mix, payer mix, etc.), clinical operations (patient throughput and usage metrics for the operating room, emergency department, radiology, laboratory, pharmacy, materials, etc.), physician details and utilization (diagnosis related groupings, procedures, coding, scheduling, labor, materials, etc.) patient encounter details (volumes, admissions, discharges, transfers, readmissions, diagnosis related groupings, coding, payer details, satisfaction, etc.) quality of patient care (diagnosis, physician, length of stay, average length of stay, average geo mean length of stay, readmissions, etc.), and 3^{rd} party (patient satisfaction, patient volumes, costs, State health care data, etc.) automatically; and for comparative benchmarking with other suitable healthcare facilities or groups of healthcare facilities in order to determine best practices. At the core of many of the embodiments of the present invention are a business performance management and reporting facility using a secure data extract and integration facility, a cost accounting facility, and a reporting, data analytics, and visualization facility.

In a preferred embodiment, Data Integration is performed prior to Cost Accounting. In certain embodiments, reports on individual or combined data have details that do not involve costing—i.e. Emergency Department patient flow; number of patients in ED waiting room at a particular time, Operating Room surgeon block times and scheduling, etc. Within the business performance management platform, the data extract, integration, validation, auditing, and loading begins with a Secure File Transfer Protocols (SFTP) between each respective hospital data source system or third party system(s) and is transferred to a secure data center. Within the data center, the health care provider data and any third party data runs through a data validation and data auditing program to determine if data was received from the source system(s), or if data is accurate within client or user based standard deviations to a custom or site-specific norm. Once the source data passes the automated auditing process, the data loading process commences and the data is combined and customized from each health care site, where industry-specific logic is applied in order to provide accurate information results to end users over HyperText Transfer Protocol over Secure Socket Layer (HTTPS) web browser.

Within the business performance management platform, a sophisticated cost accounting is preferably included to ensure accurate financial results to the users in order to support their business and operational decisions. Cost accounting includes the general practice of taking costs or expenses that are recorded on a general ledger system and allocating the costs and expenses to volumes of provided goods and services. In a general ledger system, costs and expenses are recorded by the department or area in which they are incurred. Since products and services provided are typically supported by multiple departments or areas, the costs recorded on the general ledger for any particular department will therefore only represent a portion of the total costs for any particular product or service. This phenomenon is particularly true in health care, as a patient will likely receive services from many different departments during the patient's treatment.

According to various embodiments of the invention, a business performance management platform is provided that includes a data extract engine facility (such as NPR, Microsoft SQL, or HL7 messages) integration, validation, monitoring and processing facility to determine data loading readiness by individual site or department, a data mapping, normalization and auditing facility to accurately accept, convert, organize, and audit the data prior to loading raw data. The business performance management platform includes a cost accounting facility that: accepts the normalized data to process relevant cost allocations to longitudinal patient level detail; performs cost accounting at the charge code level and reports on both detailed and consolidated levels; incorporates weighted Diagnosis Related Groupings (DRG's) to allocate costs for non-patient attributable services; incorporates medical codes defined as Current Procedural Terminology (CPT), for medical procedures that allows for comparability in pricing, billing, and utilization review; includes built-in reconciliations and audits; includes a series of pre-designed cost accounting report to view detailed general ledger amounts fully allocated down to the patient level, costs that are distributed to individual activities and services down to the charge description master for inpatient and outpatients; captures an unlimited number of cost components, integrates reclassification rules and non-standard cost definitions; and provides automated schedule of allocations to run at user specified times. The business performance management platform combines: financial details; gross, net and expected revenue details; medical claim details; DRGs; CPTs; labor and productivity details; clinical operations, scheduling and materials details; physician details, etc.; patient encounter details; quality of patient care details; and relative 3^{rd} party data with the processed cost accounting data into a multi tenant data warehouse that processes, stores and applies proprietary industry-specific logic to the resultant data. The business performance platform includes a user interface consisting of dashboards, scorecards, summary level reports, detailed analytics reports, self-service and Ad hoc reporting, comparative benchmarking, automated alerting and reporting, and automated email distribution that are securely made available by individual user or system administrator through HTTPS web protocols.

The business performance management platform enables users with near real time results of the performance metrics associated with financial cost, revenue, profitability, and service line details, clinical operations details, materials details, physician details, patient encounter details, and quality of patient care characteristics of the user's healthcare facilities, derived from a summary of patient and physician level data and detailed patient and physician level data to analyze results of overall profitability of patient care for individuals, groups, and/or for healthcare facilities.

The information produced from the business performance management platform may be used for one or more, preferably at least two, and more preferably at least five or more of the following: generating, calculating, and modeling integrated reporting for financial (detailed cost, net revenues, expected revenues, profitability, case mix, payer mix, service line performance, etc.), clinical operations (time stamps of procedures, operating room, emergency department, radiology, laboratory, pharmacy, materials, etc.), physician details and utilization (procedures, diagnosis related groupings, scheduling, labor, materials, CPTs, etc.) patient encounter details (volumes, admissions, discharges, transfers, locations, time stamps of procedures, readmissions, diagnosis related groupings, coding, and satisfaction, etc.) and quality of patient care (diagnosis, length of stay, average length of stay, average geo mean length of stay, readmissions, etc.) automatically; and for comparative benchmarking with other suitable healthcare facilities or groups of healthcare facilities in order to determine best practices.

Certain patents and patent publications are incorporated in their entireties herein by this reference to provide additional support with respect to written description and enablement requirements, including the following:

2009/0055439 to Pai et al., U.S. Pat. No. 7,822,623 for Gragg et al., 2010/0274580 to Crownover et al., 2010/0223244 to Sinha et al.; 2011/0077958 to Breitenstein et al. and U.S. Pat. No. 7,467,094 to Rosenfeld.

The business performance management platform as referred to herein and that is employed in many of the embodiments of the present invention also includes the following U.S. patents, all of which are incorporated herein by this reference:

U.S. Pat. No. 8,069,349, entitled “Method of secure file transfer” to Israel;

U.S. Pat. No. 8,245,288, entitled “Method and arrangement for providing security through network address translations using tunneling and compensations” to Kivinen;

U.S. Pat. No. 8,244,759, entitled “Systems and methods for exporting, publishing, browsing and installing on-demand applications in a multi-tenant database environment” to Brooks;

U.S. Pat. No. 8,244,658, entitled “System, method and computer program product for generating a set of instructions to an on-demand database service”

U.S. Pat. No. 8,126,740, “Electronic health record case management system” to Busch;

U.S. Pat. No. 8,200,501, entitled “Methods, systems and computer program products for synthesizing medical procedure information in healthcare databases” to Friedlander;

U.S. Pat. No. 8,050,938, entitled “Integrated medical software system with enhanced portability” to Green, Jr.;

U.S. Pat. No. 8,204,929, entitled “Hiding sensitive information” to Roginsky; U.S. Pat. No. 8,239,916, entitled “Methods, data processing systems, and computer program products for assigning privacy levels to data elements” to Reeves; U.S. Pat. No. 8,209,248, entitled “Method and system for building audit rule sets for electronic auditing of documents” to Dubinsky;

U.S. Pat. No. 8,055,747, entitled “Message based network transmission for selection and auditing of interne services” to Mazur;

U.S. Pat. No. 8,239,852, “entitled “Remote update of computers based on physical device recognition” to Etchegoyen;

U.S. Pat. No. 8,244,725, entitled “Method and apparatus for improved relevance of search results” to Woosley;

U.S. Pat. No. 8,244,667, entitled “Querying multidimensional data with independent fact and dimension pipelines combined at query time” to Weinberger;

U.S. Pat. No. 8,234,292, entitled “System, method, and computer-readable medium for optimizing processing of queries featuring maximum or minimum equality conditions in a parallel processing system” to Xu;

U.S. Pat. No. 8,244,714, entitled “On-demand database service system, method and computer program product for generating a custom report utilizing outer joins” to Collins;

U.S. Pat. No. 8,204,855, entitled “Method and system for synchronizing a server and an on-demand database service” to Salmon; and

U.S. Pat. No. 8,171,418, entitled “Method and system for presenting a visual representation of the portion of the sets of data that a query is expected to return” to Law.

In one embodiment, a system is employed that includes a method for accounting and billing patients who are associated with a patient identifier. Billable services provided to the hospitalized patient are associated with the patient identifier. If the billable service is provided by a physician, a physician identifier is also associated with the billable service. The hospitalized patient is scored and a current procedural terminology (CPT) assignment manager assigns CPT codes to the billable service. A bill generator receives the patient data, patient insurance information, physician insurance information, and CPT codes and generates a bill for the billable services provided to the hospitalized patient.

One will appreciate that this summary of the Invention is not intended to be all encompassing and that the scope of the invention nor its various embodiments, let alone the most important ones, are necessarily encompassed by the above description. One of skill in the art will appreciate that the entire disclosure, as well as the incorporated references, pictures, etc. will provide a basis for the scope of the present invention as it may be claimed now and in future applications.

### BRIEF DESCRIPTION OF THE FIGURES

FIG. 1 is a flowchart depicting one embodiment of the present invention.

FIG. 2 is a depiction of various aspects of certain embodiments of the present invention.

FIG. 3 is a further depiction of various aspects of certain embodiments of the present invention.

### DETAILED DESCRIPTION OF CERTAIN EMBODIMENTS OF THE INVENTION

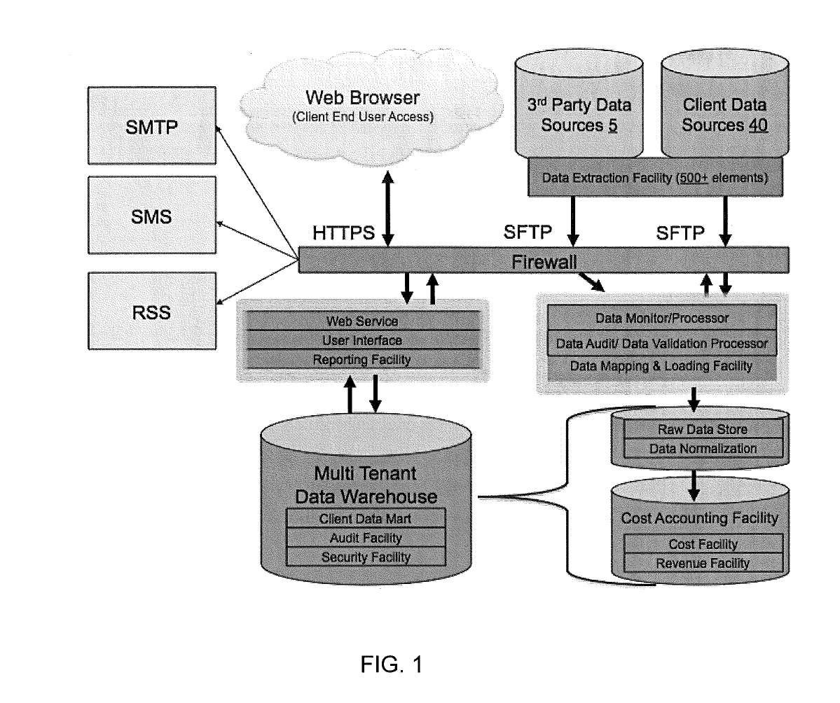

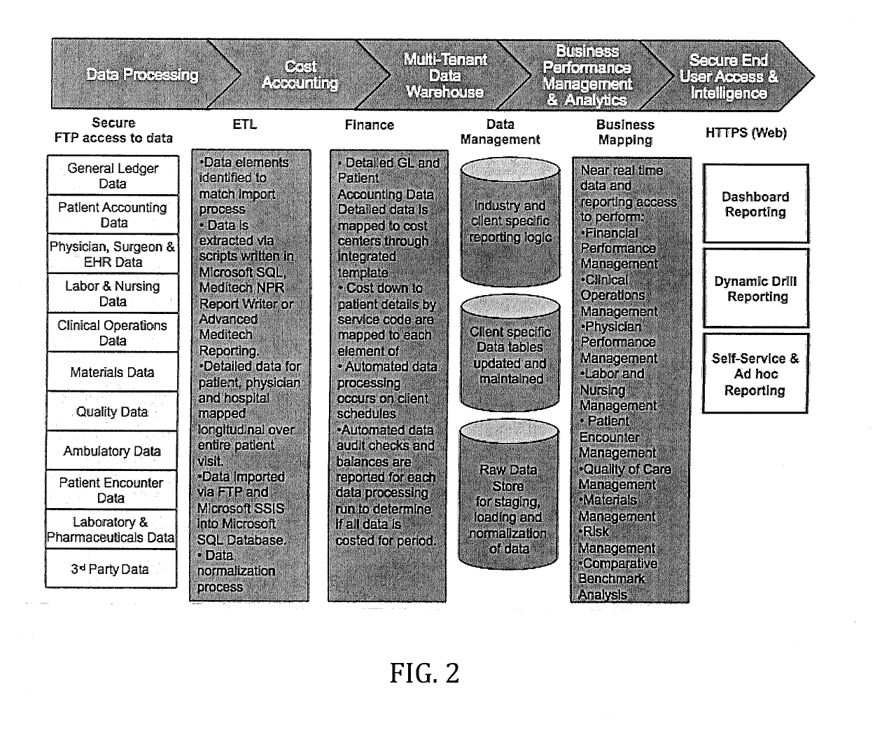

As shown in FIGS. 1-3, various alternative embodiments of the present invention are provided in illustrations that one of ordinary skill in the art will follow and understand. For example, with reference to FIG. 2, data extraction is followed by data processing, cost accounting procedures, multi-tenant data warehousing of data, employment of a finance, clinical operations and quality analytics review, and finally provision of end user access and intelligence. By employing such a system and method, it is possible to provide a business performance management platform that, with near real time operations, the ability to analyze results of overall profitability of patient care for individuals, groups and/or particular healthcare facilities.

As shown on FIG. 1, in one embodiment of the present system and method, the following steps are carried out:
1. Client Data Sources and/or 3^{rd} Party Data Sources are extracted from their source through a Data Extraction Facility such as Non-Procedural Representation (NPR), HL7 message, Microsoft SQL, Comma Separated Values (CSV), or other data extraction procedures or methods.
2. The Client Data Source and/or 3^{rd} Party Data Source files are transferred through a secure Firewall on the host side through Secure File Transfer Protocol (SFTP) Facility and are managed using a Data Monitor Processing Facility and Data Mapping and Loading Facility within a HIPAA-compliant Data Center Facility.
3. The Data Monitor Processing Facility works with a Data Audit and Data Validation Facility to determine source, size, and total size of Data Source File.
4. The Data Audit and Data Validation Facility automatically reports to the Data Monitor Facility if Data Source File is complete or incomplete.
5. If Data Source File is estimated as “incomplete” or “failed to complete” according to system administrative procedures, the Data Source File(s) is not accepted into the Raw Data Store Facility, and an automated report is generated by the Data Audit and Data Validation Facility and sent to the system administrator for troubleshooting.
6. If Data Source File is estimated as “complete” according to system administrative procedures, the Data Source File(s) is accepted into a Raw Data Store Facility, whereby the data is normalized through a Data Normalization Facility.
7. After the Data Normalization Facility has successfully run, the Normalized Data is automatically transferred and loaded into the Cost Accounting Facility.
8. Within the Cost Accounting Facility, the Normalized Data is run through a Cost Facility and a Revenue Facility where cost and revenue allocations, calculations and data audits are applied to the Normalized Data.
9. If the data audit detects errors in the Normalized Data, the Cost Accounting Facility has an Automated Data Audit Facility that will report errors to the respective parties such as system administrators and system support personnel.
10. If the Cost Accounting Facility automatically approves the respective Cost, Revenue data, the data will be automatically transferred using the Cost Accounting Facility automated Data Transfer Facility to move the Cost and Revenue Data to the Multi Tenant Data Warehouse Facility.
11. The Multi-Tenant Data Warehouse Facility includes a Client Data Mart Facility, an Audit Facility, and a Security Facility.
12. The Normalized Data from the Data Normalization Facility and/or the Cost Accounting Facility is processed and organized within the Client Data Mart Facility, whereby the Audit Facility performs data audit and validation checks to determine completion of data by client.
13. If Client Data Mart Facility automatically approves data, the prepared data is made available to end users through a Security Facility within the Multi-Tenant Data Warehouse to ensure the data is only available to the desired end users through a Web Service Facility comprised of a User Interface Facility and a Reporting Facility.
14. End users have access to their version of a User Interface Facility and Reporting Facility through a Secure Firewall Facility and an HTTPS Facility included within a Web Browser Facility.
15. The Web Service Facility also manages user access through Communication Facilities such as Simple Mail Transfer Protocol (SMTP), Short Message Service (SMS), and Really Simple Syndication (RSS) protocols and procedures.

As shown on FIG. 2, in one embodiment of the present system and method, the following steps are carried out:
1. All of the steps outlined in FIG. 1 apply to the processes shown in FIG. 2
2. Data Processing Facility includes all the data sources described under Secure FTP access to data and the detailed descriptions listed under ETL (Extract, Transfer, Loading) in FIG. 2.
3. The Cost Accounting Facility includes the details listed under Finance
4. Multi Tenant Data Warehouse Facility includes the processes described under the Data Management.
5. The Business Performance Management & Analytics Facility includes the processes described under Business Mapping.
6. The Secure End User Access & Intelligence Facility includes the outputs generated under the HTTPS (Web) section.

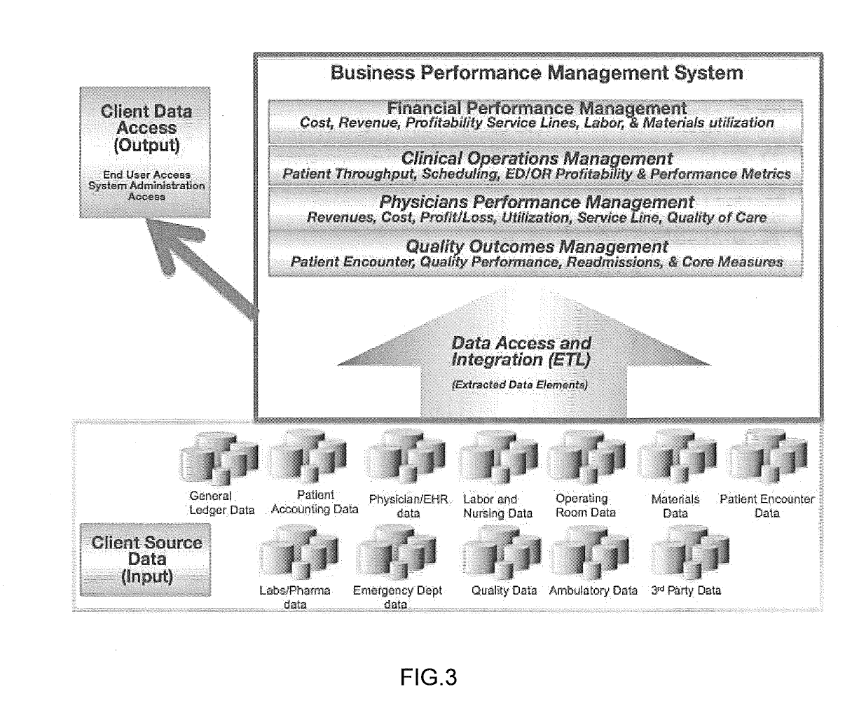

As shown on FIG. 3, in one embodiment of the present system and method, the following steps are carried out:
1. All of the steps outlined in FIG. 1 above apply to the processes shown in FIG. 3.
2. The Client Source Data (Input) is the representative source systems such as General Ledger Data, Patient Accounting Data, Physician/EHR Data, Labor & Nursing Data, Operating Room Data, Materials Data, Patient Encounter Data, Laboratory/Pharmacy Data, Emergency Department Data, Radiology Data, Quality Data, Ambulatory Data, 3^{rd} Party Data, etc.
3. The Data Access and Integration (ETL) Facility encompasses the processes described in FIG. 1.
4. The Business Performance Management System comprises a User Interface Facility that is organized in individual Computer Applications such as Financial Performance Management Application, Clinical Operations Management, Physician Performance Management, Quality Outcomes Management, etc.
5. Client Data Access is accomplished through the processes described in FIG. 1 above.
6. The Business Performance Management System includes an integrated System Administration Facility that can be managed through Client Data Access within an HTTPS Web Browser Facility so that End Users with appropriate access and data security may manipulate their End User Access and End User Security.
7. The System Administration Facility includes access to the Data Audit and Data Validation Reporting Facility described in FIG. 1 above.

In one embodiment, the present invention is directed to a computer system for providing a business performance management platform that includes the following:
a) a data extraction, integration, monitoring and processing facility for determining data loading readiness by an individual site or a department;
b) a data mapping and normalization system that accepts, transforms, validates, and audits data prior to loading raw data;
c) a cost accounting system that performs at least two of the following:
   1) accepts the normalized data to process relevant cost allocations to longitudinal patient level detail;
   2) performs cost accounting at the charge code level and reports on both detailed and consolidated levels;
   3) incorporates weighted Diagnosis Related Groupings (DRG's) to allocate costs for non-patient attributable services; generates reconciliations and audits;
   4) generates a series of pre-designed cost accounting reports that provide detailed general ledger amounts fully allocated down to the patient level;
   5) distributes costs to individual activities and services down to the charge description master for inpatient and outpatients;
   6) captures cost components;
   7) integrates reclassification rules and non-standard cost definitions; and
   8) provides automated schedule of allocations to run at user specified times;
d) a logical stored data procedures engine that holds industry-specific calculations and performs at least 2 of the following:
   1) generates a series of pre-designed reports that provide detailed and summary level details at the individual patient, physician, organization, or responsible party level; (Note that a logical stored data procedure engine may include a “Standard Query Logic or SQL”.)
   2) performs routine updates to reports based on preferred schedule by individual site or user;
   3) allows users automated report access with ability to customize reports based on security level and job function; and
e) a user interface comprising dashboards, scorecards, summary level reports, detailed analytics reports, comparative benchmarking alerting and email distribution that are securely made available by an individual U.S.er through HTTPS web protocols.

In various embodiments, a platform employed combines the financial, clinical operations, physician, patient encounter, quality of patient care, and relative 3^{rd} party data with processed cost accounting data into a multi tenant data warehouse. Such a platform enables users to access near real time results of performance metrics associated with financial, clinical operations, physician, patient encounter, and quality of patient care characteristics of a user's healthcare facilities, such results obtainable from a summary of patient or physician level data, which are analyzed in terms of one or more relevant statistics, such as physician and labor utilization, costs, revenues, patient volumes, patient admissions, patient discharges, patient readmissions, patient throughput, scheduling, case mix, payer mix, patient population care, and overall profitability tied to patient care for an individual or a group of healthcare facilities.

Other embodiments include a central database for storing captured data, the captured data including at least two, and preferably at least three of the following: patient accounting data, clinical operations data, resource utilization data, general ledger data, electronic health record/electronic medical record data, and/or 3^{rd} party patient-related data.

In yet further embodiments, the system includes a retrieval component to retrieve captured data from the central database. In a preferred embodiment, client data source systems for data extraction include: Meditech (3 versions), Cerner (1 version), McKesson (2 versions), Siemens (2 versions), eClinicalWorks (1 version), Eclipsys (2 versions), Lawson (1 version), Picis (1 version), and Allscripts (1 version).

3^{rd} Party Data Sources include:
State Clinical and Financial Comparative Data (e.g., integrated with state records, such as New York, Maine, Massachusetts, & Indiana)
Center for Medicare and Medicaid Services (CMS)—Comparative data for Clients to Diagnosis Related Groupings (DRG) data
Press-Gainey Patient Satisfaction

### DEFINITIONS

SMTP: Simple Mail Transfer Protocol: a protocol for transferring e-mail messages over the Internet.
SMS: Short Message Service: a system for sending short text messages, as from one cell phone to another or from a computer to a cell phone.
RSS: Really Simple Syndication: an XML-based standard and format used to distribute recent news and other frequently updated content appearing on a Web site: an RSS reader, RSS files, and RSS feeds.
Multi Tenant Data Warehouse: Please refer to U.S.PTO Patent Application 20090055439, Flexible dimension approach in a data warehouse.
FTP: File Transfer Protocol: a system for transferring data from one server to a target system.
SFTP: Secure File Transfer Protocol: an encrypted (secure) system for transferring data from one system to a target system.
EHR/EMR: Electronic Health Record/Electronic Medical Record: a system for storing, managing, and viewing electronic patient and medical-related data that is input from health care providers.
NPR: Non-Procedural Representation: is a system for extracting data from proprietary source systems
HL7: Health Language 7 refers to some of the specific standards created by a non-profit organization named “Health Language 7” and its members to provide a framework (and related standards) for the exchange, integration, sharing, and retrieval of electronic health information standards, which support clinical practice and the management, delivery, and evaluation of health services, are the most commonly used in the world.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention. Those skilled in the art will appreciate that the conception upon which this disclosure is based, may readily be utilized as a basis for designing of other structures, methods and systems for carrying out the several purposes of the present invention. It is important, therefore, that the claims be regarded as including any such equivalent construction insofar as they do not depart from the spirit and scope of the present invention.

What is claimed is:

1. A computer system providing a business performance management platform, comprising:
a) a data extraction, integration, monitoring, auditing, validation, and processing facility for determining data loading readiness by an individual site or a department;
b) a data mapping and normalization system that accepts, transforms, validates, and audits data prior to loading raw data;
c) a cost accounting system that performs at least two of the following:
i) accepts the normalized data to process relevant cost allocations to longitudinal patient level detail;
ii) performs cost accounting at the charge code level and reports on both detailed and consolidated levels;
iii) incorporates weighted Diagnosis Related Groupings (DRG's) to allocate costs for non-patient attributable services; generates reconciliations and audits;
iv) generates a series of pre-designed cost accounting reports that provide detailed general ledger amounts fully allocated down to the patient level;
v) distributes costs to individual activities and services down to the charge description master for inpatient and outpatients;
vi) captures cost components;
vii) integrates reclassification rules and non-standard cost definitions; and
viii) provides automated schedule of allocations to run at user specified times;
d) a logical stored data procedures that holds industry-specific calculations and performs at least 2 of the following:
i) generates a series of pre-designed reports that provide detailed and summary level details at the individual patient, physician, organization, or responsible party level;
ii) performs routine updates to reports based on preferred schedule by individual site or user.
iii) allows users automated report access with ability to customize reports based on security level and job function;
e) a user interface comprising dashboards, scorecards, summary level reports, detailed analytics reports, comparative benchmarking alerting and email distribution that are securely made available by an individual user through HTTPS web protocols;
f) wherein said platform combines the financial data (such as cost, revenues, profitability, etc.), clinical operations (such as operating room, emergency department, radiology department, laboratory department, physician, electronic health records, patient encounter, labor, resource utilization, materials, quality of patient care, etc.), and relative 3^{rd} party data (such as patient satisfaction, State patient data, etc.) with processed cost accounting data into a multi tenant data warehouse; and
g) wherein said platform enables users to access near real time results of performance metrics associated with financial, clinical operations, physician, patient encounter, and quality of patient care characteristics of a user's healthcare facilities from summary of patient or physician level data to analyze results such as statistics, physician and labor utilization, costs, revenues, patient volumes, patient admissions, patient discharges, patient readmissions, patient throughput, scheduling, case mix, payer mix, patient population care, and overall profitability tied to patient care for an individual or a group of healthcare facilities.

2. The system of claim 1, further comprising a central database for storing captured data, the captured data including patient accounting, clinical operations data resource utilization data, electronic health record/electronic medical record data, and/or 3^{rd} party data.

3. The system of claim 1, further comprising a central database for storing captured data, the captured data including patient accounting, general ledger, clinical operations data such as operating room, emergency department, radiology department, laboratory department, pharmacy department, labor, materials, resource utilization data, electronic health record/electronic medical record data, quality of care data, patient satisfaction data, etc., and/or 3^{rd} party data, comprising a method for determining data loading readiness by system administrator(s) and customer support personnel, an individual user, site, or department utilizing one of: a) Multi Tenant Data Warehouse facility that organizes and stores the normalized data; b) a Client Data Mart; c) an Audit Facility to determine if all data is accurate and loaded; and d) a Security Facility to ensure data is only available to end users and that have been assigned by system administrator with secure system login credentials featuring user name and passwords.

4. The system of claim 2, wherein a retrieval component is employed to retrieve captured data from the central database.

5. A method for providing a business performance management platform, comprising:
a) enabling end user access through a Reporting Facility that provides access to normalized data that is combined with stored query logic (SQL) to produce results to end users;
b) providing end user access through a User Interface Facility:
i) written in HTML, Java, Opensource or similar web development code;
ii) including user experience of selecting standard reports and analytics for dynamic or drill down;
iii) including dashboards, charts, reports displayed to enable users with visual representation of data for trending, alerting users of performance by department, service line, individual, group of individuals, or other Color coding of data or groups of data within charts, graphs or reports that can be customized by end user or system administrator(s) in order to signify status of performance
iv) including an Ad hoc reporting facility for manipulating data, creating and retrieving reports;
v) converting or exporting to other reporting or data manipulation tools and applications;
vi) distributing manually on demand through email, SMS, or other services; and
vii) distributing automatically through Web Services Facility functions over email, SMS, or other services;
c) managing data retrieval logic through a Web Services Facility securely through a Firewall Facility; and
d) accessible over HTTPS through a Web Browser Facility, an RSS facility, an SMS facility, an SMTP Facility.

6. A method for providing a business performance management platform, comprising: assessing one of a Data Source File's origin or source using a data validation facility that includes information relating to a site's location or the time it was received; if the Data Source File's origin or source is from a known system, then:
a) transferring the Data Source File into a staging area within the computer system and performing a data audit to determine whether a Data Source File is either incomplete or failed;
b) generating an automated report if the data source file is either incomplete or complete;
c) identifying a user name and facility name for the incomplete or complete Data Source File;
d) sending the automated report to a system administrator responsible for the Data Source File, said automated report indicating whether the data Source File is within a standard deviation selected by the system administrator or whether it is outside the standard deviation; and
e) alerting the system administrator that a Data Source File was not complete or not received in time to update the business performance management platform.

7. A method for data extraction from within a host source computer system comprising:
a) determining if a host Data Source File comprises a list of data elements expected from host computer system
b) generating a Data Source File using SQL, NPR, HL7, CSV, or similar data extract processes
c) creating a completed Data Source File within the host computer system
d) transferring the Data Source File to a spool group file server within the host computer system
e) readying the Data Source File to be transferred from the host computer system
f) transferring the Data Source File to one of a network server drive or a location where the data source file can be either processed or compressed by the host computer system using a secure data encryption process; detecting a presence of an encrypted. Data Source File;
i) Logging each of a date, time, type, and size of the encrypted Data Source File;
ii) Transferring the encrypted Data Source File using either a SFTP or WinSCP process;
iii) Retrieving Data Source File by employing a secure login process;
iv) Unzipping the Data Source File
v) Transferring the Data Source File to a Data Validation Facility;
g) determining data readiness of the data source file by employing the Data Validation Facility;
h) verifying whether an SFTP process performed on the Data Source File is complete;
i) notifying a system administrator automatically through email or via a SMS of the readiness of the Data Source File;
j) determining if the Data Source File should be automatically transferred to a Data Audit Facility by:
i) assessing the data accuracy of the Data Source File as compared to a customized standard deviation that is stored in the Data Audit Facility, whereby if it is determined that the Data Source File are inaccurate or outside the custom standard deviation, an auto-generated message is sent to the Data Source File system administrator(s) to trouble shoot and restart the SFTP process; or determined that the SFTP process is successful, the host of the Data Source File is sent to a data server using SFTP and an email notification is sent;
k) Transferring the Data Source File that is accurate to a Data Mapping and Loading facility;
l) processing the accurate Data Source File from the Data Audit Facility to the Data Mapping and Loading Facility;
m) loading the data source files into the Raw Data Store facility;
n) normalizing the data source data;
o) transferring the data source data to either to a Cost Accounting facility or the central database; and
p) readying the normalized data for end user access.
